(19) United States
(12) Patent Application Publication
(10) Pub. No.: US 2010/0268129 A1
(43) Pub. Date: Oct. 21, 2010

(54) GAIT TRAJECTORY GUIDING DEVICE OF GAIT REHABILITATION DEVICE

(75) Inventor: Seung Hun Park, Gyeonggi-do (KR)

Correspondence Address: LRK Patent Law Firm, 1952 Gallows Rd, Suite 200, Vienna, VA, 22182, US

(73) Assignees: KLMED CO., LTD., Gangwon-do (KR); KYUNGHEE UNIVERSITY INDUSTRY FOUNDATION, Seoul (KR)

(21) Appl. No.: 12/160,991

(22) PCT Filed: Sep. 14, 2007
(86) PCT No.: PCT/KR2007/004447

§ 371 Date: Jun. 24, 2010

(30) Foreign Application Priority Data
Sep. 10, 2007 (KR) 10-2007-0091586

(51) Int. Cl. A61H 1/00

(52) U.S. Cl. 601/35

(57) ABSTRACT

A gait trajectory guiding device of a gait rehabilitation apparatus is disclosed. The gait trajectory guiding device includes a pair of guideway actuating plates (11), which are arranged parallel to each other, and each of which is provided with a horizontal screw, and a pair of guideways (20), which are provided on each guideway actuating plate. Each guideway is individually moved by rotation of the corresponding horizontal screw in the longitudinal direction of the guideway actuating plate. The device further includes footboards (30), which are coupled to the corresponding guideways such that the front and rear parts of each footboard are individually adjustable in height. Therefore, the footboards are actuated by the guideways along trajectories similar to the movement of the feet of a person when actually walking, thus enabling a user to conduct gait training in a correct walking motion, thereby increasing rehabilitation effect.

### TECHNICAL FIELD

The present invention relates, in general, to gait devices of gait rehabilitation apparatuses for rehabilitation exercise and, more particularly, to a gait trajectory guiding device of a gait rehabilitation apparatus which has pressure sensors and is constructed such that footboards for supporting the feet of a user are operated along linear guideways that follow an ideal gait trajectory equal to that when actually walking, so that a normal person, as well as a rehabilitation patient who need a walking exercise device, can conduct gait exercise in a correct walking posture.

### BACKGROUND ART

In modern times, work using computers has been increased in almost all industries, and, thus, modern people, who do not regularly exercise, have been exposed to an increased risk of adult diseases, such as hypertension, cerebral apoplexy, and cerebral hemorrhaging, attributable to overeating, lack of exercise, and excessive smoking and drinking.

Furthermore, in modern society, the types of disorders attributable to various accidents have been increased. Particularly, the incidence of disorders, by which it is impossible to walk due to an adult disease or a cerebral injury resulting from an accident, or by which normal life is difficult due to an injury to a locomotive organ or muscles, has increased.

In addition, in the case of a gait disorder, in which it is difficult to freely move the legs, normal life becomes more difficult. Because a limitation is consequently placed on exercise, the disordered part may atrophy because of the lack of exercise after becoming afflicted with the disorder.

Therefore, gait-disabled patients who have difficulty in walking, the elderly, who injure their joints or bones, or patients who undergo operations on artificial hip joints, must continuously undergo rehabilitation therapy, that is, they must steadily undergo gait training using walking assistant devices. In the case where they steadily undergo the gait training, rehabilitation of about 60% can be achieved.

However, the gait-disabled patients or the old, who must undergo the gait training, need assistants and experts in various fields, and, generally, they use only basic gait assistant devices, such as crutches or walkers. Therefore, it is difficult to spontaneously conduct the gait training and to ceaselessly undergo the gait training without assistance.

Particularly, to increase the sense of equilibrium of patients and the endurance required for continual training, repeated and systemic gait training is necessary. For this, training, in which a patient walks along an artificial gait trajectory, has been repeatedly conducted with the assistance of a therapist who administers rehabilitation therapy.

Furthermore, in the conventional arts, typically, gait training using a treadmill has been used. In the case of gait training using the treadmill, a user can continuously conduct the gait training in a relatively small space. However, there is a disadvantage in that, while using the treadmill, an expert therapist must control the motion of the body of the user to help maintain equilibrium and guide the correct walking motion.

To solve the above-mentioned disadvantages and enable gait-disabled patients to actively and functionally conduct gait training, various gait rehabilitation apparatuses, which are constructed such that a user can conduct gait training in a state in which his/her body is reliably supported, and which have an exercise extent adjustment function, have been developed.

As a representative example of the conventional techniques, a gait rehabilitation apparatus (in Korean Patent Laid-open Publication No. 2007-53533, entitled: GAIT TRAINER WITH EXERCISE PRESCRIPTION CAPABILITY), which was filed by the applicant of the present invention and has been registered, will be explained with reference to the following attached drawings.

FIG. 1 is a perspective view showing the conventional gait rehabilitation apparatus. As shown in the drawing, the conventional gait rehabilitation apparatus includes a lower frame 105, a support frame 110, a load support rod 115 and a handle 120. The conventional gait rehabilitation apparatus further includes pedals 140, on which the feet of a user are placed, a pedal actuating unit 130, which actuates the pedals 140, a display 190 and a control unit 150.

The gait rehabilitation apparatus further includes a weight absorption unit 180, which absorbs a load attributable to the weight of the user, and a holder 170, which holds the body of the user.

The operation of the conventional gait rehabilitation apparatus having the above-mentioned construction will be briefly explained herein below. After the user places his/her feet on the respective pedals 140, the pedal actuating unit 130 actuates the pedals such that the feet of the user move in a manner similar to that when walking. Thereby, because the pedal actuating unit 130 directly actuates the pedals 140, the user can obtain an exercise effect even though the user cannot move his/her feet for himself/herself.

In detail, although the user does not pedal the pedals 140 for himself/herself, the feet of the user are moved by the operation of the pedal actuating unit 130. At this time, depending on the movement of the pedals 140, the center of gravity of the user alternately moves to the left and the right, so that the user moves his/her body in the direction such that the center of gravity is maintained, thus obtaining exercise effect.

However, in the conventional gait rehabilitation apparatus, the pedals 140, on which the feet of the user are placed, are moved only upwards and downwards, and the pedals 140 maintain the horizontally oriented state while actuating.

Here, of course, the pedals 140 may be constructed such that they move in response to the movement of the user rather than maintain the horizontally oriented state. However, because the trajectory along which the pedals are actuated is fixed, it is difficult to adjust the trajectory depending on the user when gait training. Furthermore, even if the apparatus may be constructed such that the length of the step can be adjusted using a separate mechanical device, there is a problem in that it is also difficult to adjust the trajectory.

Therefore, although a user who places his/her feet on the pedals 140 can conveniently conduct gait training using vertical movement of the pedals 140 depending on the operation of the pedal actuating unit 130, because the feet of the user are fixed to the upper surface of the pedals 140, which maintain the horizontal state, it is difficult to ensure an exercise effect similar to that realized when the user actually walks.

In other words, because the ankles of the feet, which are placed on the respective pedals 140, do not move, the motion of the knee joints, which move in conjunction with respective ankles, differs from that when actually walking. Therefore, there is a disadvantage in that the training effect relative to the training time is markedly reduced.

Furthermore, the conventional gait rehabilitation apparatus repeats only basic motions in which the knee joints of the user are bent and stretched by the vertical movement of the front part of the pedal actuating unit 130, which is coupled to the pedals 140, thus being boring for the user.

In addition, because the trajectory and orientation of the pedals are constant, the adjustment of the height of the pedals 140 and the range within which the pedals 140 are actuated are limited. As a result, fatigue may be undesirably concentrated on specific portions of the body of the user.

### DISCLOSURE

### Technical Problem

Accordingly, the present invention has been made keeping in mind the above problems occurring in the prior art, and an object of the present invention is to provide to a gait trajectory guiding device of a gait rehabilitation apparatus in which pressure sensors are provided in footboards for supporting the feet of a user, so that, depending on the exercise performance conditions of the user, the gait trajectory can be adjusted, and which is constructed such that the footboards are operated along guideways that follow a gait trajectory similar to that when actually walking, thus making it possible to conduct gait training in the correct motion along a gait trajectory similar to that when actually walking.

Another object of the present invention is to provide a gait trajectory guiding device of a gait rehabilitation apparatus which is constructed such that the height and the inclination of the footboards can be easily adjusted, thus enabling the user to conduct gait training along a correct gait trajectory.

### Technical Solution

In order to accomplish the above objects, the present invention provides a gait trajectory guiding device of a gait rehabilitation apparatus, including: guideway actuating plates supported on the ground; a pair of guideways, which move in the longitudinal direction of each guideway actuating plate; and a footboard, which is provided on inner portions of the guideways such that the height of front and rear parts of the footboard are adjustable.

Preferably, the guideway actuating plates are arranged parallel to each other such that they face each other. A horizontal screw is provided through each guideway actuating plates along the longitudinal axis thereof. A motor, which is coupled to one end of the horizontal screw to rotate the horizontal screw, is provided on the corresponding end of each guideway actuating plate.

Furthermore, the pair of guideways is provided on each guideway actuating plate, and the guideways are individually moved forwards or backwards by the rotation of the corresponding horizontal screw.

In addition, a vertical screw is provided in each guideway, and a footboard actuating unit is provided on the vertical screw so as to be movable upwards or downwards along the vertical screw. The footboard is coupled at predetermined positions to the inner portions of the footboard actuating units of the guideways so that the front and rear parts of the footboard are individually adjusted in height by the footboard actuating units.

As well, a motor is provided on the upper end of each guideway to move the corresponding footboard actuating unit in the vertical direction.

Here, each motor, which is coupled to the horizontal screw of the corresponding guideway actuating plate, and each motor, which is coupled to the vertical screw of the corresponding guideway, respectively transmit rotating force to the corresponding horizontal screw and vertical screw through ball screws.

The guideways are provided on a guideway support plate, which is moved forwards or backwards on each guideway actuating plate. The guideways are oriented in the vertical directions and are surrounded and supported by a guideway support frame, which is vertically provided on the guideway support plate.

The two adjacent guideways have different heights. That is, because variation in the height of the rear part of the footboard, which is coupled to the guideway and support the heel of the foot of a user, is greater than that of the front part of the footboard, the guideways are configured such that the rear guideway is higher than the front guideway.

Meanwhile, each footboard has a planar shape and is provided in the upper surface thereof with a plurality of pressure sensors. The footboard is provided on a pair of footboard support rods, which extend inwards from the corresponding footboard actuating units.

Here, support rod coupling members extend downwards from the footboard. The support rod coupling members are rotatably coupled to the respective footboard support rods, so that the footboard is rotatably coupled to the footboard actuating units. Thus, the front and rear parts of the footboard are rotated around the corresponding footboard support rods by the individual vertical movement of the footboard actuating units along the corresponding vertical screws.

To couple the footboard support rod of the footboard actuating unit of the rear guideway to the corresponding support rod coupling member of the footboard, the footboard support rod is inserted into a coupling slot, which is, formed in the support rod coupling member and extends a predetermined length. Hence, when the corresponding footboard actuating unit moves upwards, the rear footboard support rod moves along the coupling slot, so that the footboard can be smoothly rotated.

In the gait trajectory guiding device according to the present invention, having the above-mentioned construction, each of the footboards, on which the feet of the user are placed, is rotated by the difference in height between the corresponding footboard actuating units, which are provided on the two adjacent guideways and are individually moved. The angle at which the footboard is rotated is determined such that the footboard is actuated along a trajectory similar to the trajectory along which the sole of the foot is moved when actually walking.

Therefore, in the case where the user conducts gait training using the gait trajectory guiding device of the present invention, the feet of the user and the knee joints, connected to the feet, can be moved by the footboards, which actuate along the preprogrammed gait trajectory, in the same manner as when actually walking. Accordingly, gait disorders of the user can be treated in a relatively short period.

### Advantageous Effects

As described above, in a gait trajectory guiding device of a gait rehabilitation apparatus according to the present invention, footboards are moved forwards and backwards and, simultaneously, the heights and inclinations of the footboards vary according to a preset program. As well, the present invention is constructed such that the footboards are actuated along a trajectory similar to the trajectory along which the feet of a person are moved when actually walking, thus enabling a user to conduct gait training in a correct walking posture, thereby enhancing the effect of rehabilitation.

Furthermore, a gait trajectory suitable for the body conditions and status of the user is programmed using a computer, and the gait trajectory guiding device is designed such that the footboards are actuated along the programmed gait trajectory, thus effectively conducting the rehabilitation training. Here, the programmed gait trajectory is determined by the length of the step of the user, the heights of the soles of the feet, the inclinations of the feet and the positions of the feet when walking.

Furthermore, in the present invention, the heights and inclinations of the footboards, on which the feet of the user are placed, vary depending on the positions of the footboards along the program, which has been configured in advance to correspond to the body conditions and status of the user. Hence, there is an advantage in that optimum gait conditions suitable for a gait rehabilitation patient can be embodied.

Moreover, the footboards are actuated in the same manner as the movement of the feet when actually walking. The movement of the footboards and the heights of the footboards are controlled by the footboard actuating units at the same time. Accordingly, unlike the conventional gait rehabilitation apparatus, in which the legs of the user are merely reciprocated, in the present invention, in which the feet, the ankles and the knee joints are moved in conjunction with each other, combined exercise effects can be exhibited.

### DESCRIPTION OF DRAWINGS

FIG. 1 is a perspective view showing a conventional gait rehabilitation apparatus;

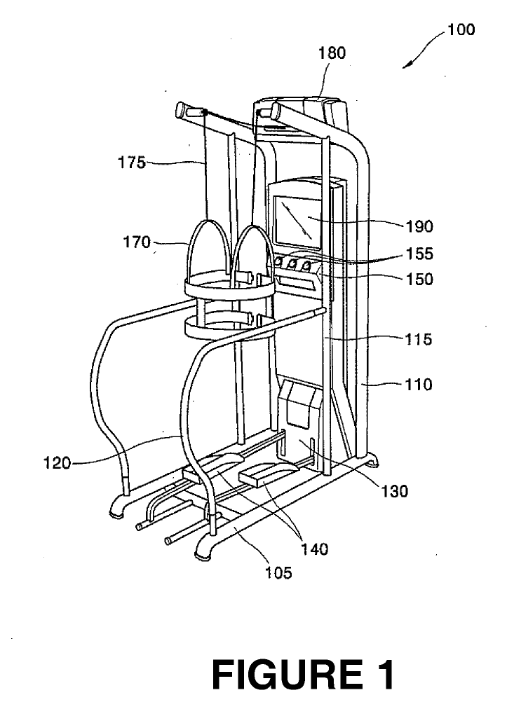

FIG. 2 is a perspective view of a gait trajectory guiding device, according to the present invention;

FIG. 3 is a front view of the gait trajectory guiding device according to the present invention;

FIG. 4 is a side view of the gait trajectory guiding device according to the present invention;

FIG. 5 is a plan view of the gait trajectory guiding device according to the present invention;

FIG. 6 is a plan view of a footboard actuating unit used in the gait trajectory guiding device according to the present invention;

FIG. 7 is a front view of the footboard actuating unit of the gait trajectory guiding device according to the present invention;

FIG. 8 is a side view of the footboard actuating unit of the gait trajectory guiding device according to the present invention;

FIGS. 9 and 10 are views illustrating the operation of the footboard actuating unit of the gait trajectory guiding device according to the present invention; and

FIGS. 11 through 13 are schematic views showing the orientation of a footboard of the gait trajectory guiding device when it is operated according to the present invention, in which:

FIG. 11 is a schematic view when supporting a heel of a foot,

FIG. 12 is a schematic view when the entire sole of the foot contacts the ground, and

FIG. 13 is a schematic view of the case where the toes of the foot are supported when the foot pushes the ground to generate propulsive force.

### DESCRIPTION OF THE ELEMENTS IN THE DRAWINGS

11. guideway actuating plate 12. horizontal screw
13,24. motor 20. guideway
23. vertical screw 25. footboard actuating unit
28. footboard support rod 30. footboard
31. pressure sensor 32,33. support rod coupling member

### BEST MODE

The technical construction and operation of a gait trajectory guiding device of a gait rehabilitation apparatus according to the present invention for achieving the above objects will be more clearly understood from the following detailed description of a preferred embodiment, taken in conjunction with the accompanying drawings.

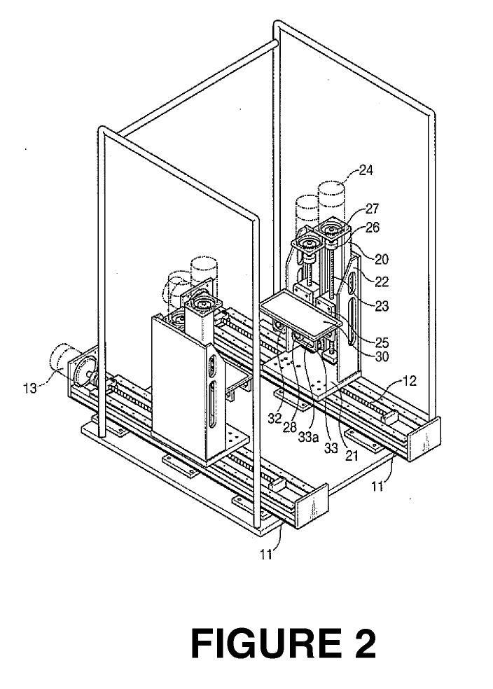

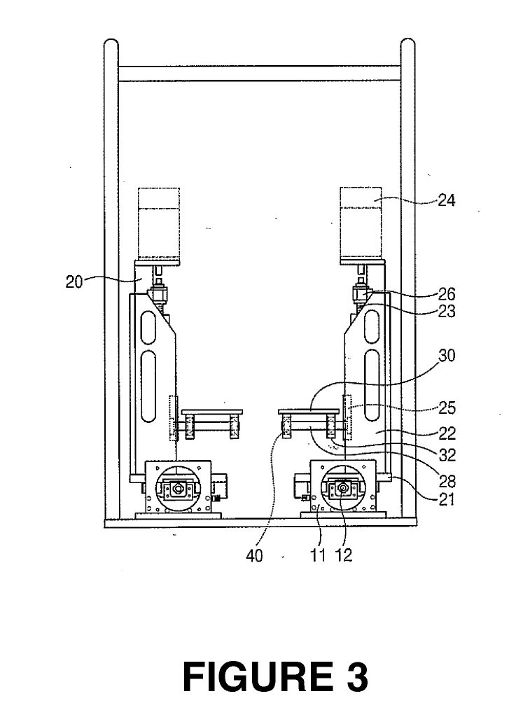

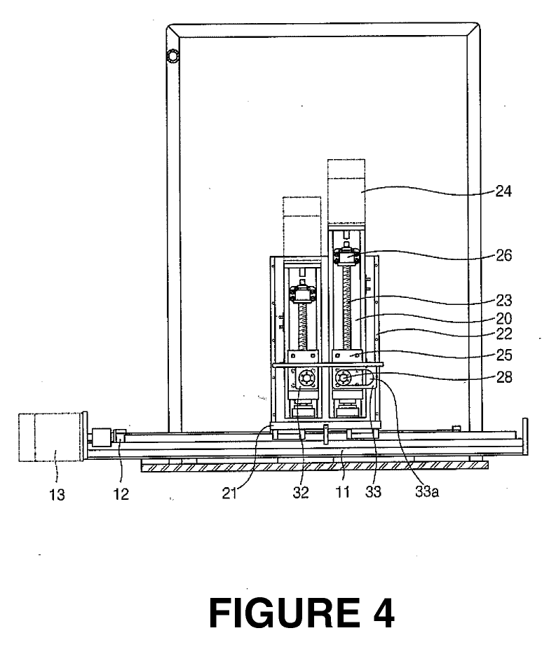

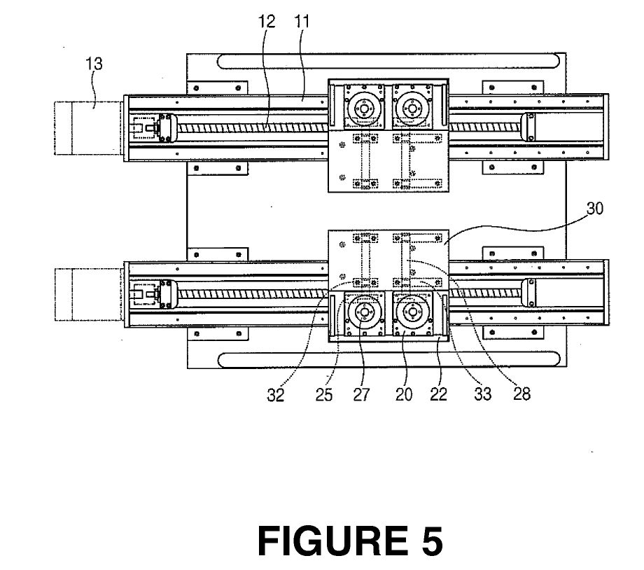

FIG. 2 is a perspective view of the gait trajectory guiding device, according to the present invention. FIG. 3 is a front view of the gait trajectory guiding device according to the present invention. FIG. 4 is a side view of the gait trajectory guiding device according to the present invention. FIG. 5 is a plan view of the gait trajectory guiding device according to the present invention.

It is self-evident that the gait trajectory guiding device of the present invention, which will be described herein below, can be installed in the conventional gait rehabilitation apparatus. Therefore, because the construction of the gait rehabilitation apparatus, in which the gait trajectory guiding device of the present invention is installed, is almost the same as in the conventional technique, other than the construction of the present invention, the detailed description of components that are the same as those of the conventional technique will be skipped.

As shown in the drawings, the gait trajectory guiding device according to the present invention includes guideway actuating plates 11, each of which has a horizontal screw 12 therein, a pair of guideways 20, which are provided on each guideway actuating plate 11, and footboards 30, which are provided on the inner portions of the corresponding guideways 20.

The guideway actuating plates 11 are disposed in a pair at left and right positions spaced apart from each other by a distance corresponding to the width of the stance of a user. Each guideway actuating plate 11 has a planar shape having a predetermined length. The horizontal screw 12 is installed in each guideway actuating plate 11 along the longitudinal axis thereof.

The horizontal screw 12 is rotated by the operation of a motor 13, which is mounted to one end of each guideway actuating plate 11. Depending on the rotation of the horizontal screw 12, the corresponding guideways 20 move in the horizontal direction above the horizontal screw 12.

The guideways 20 move in the longitudinal direction of the corresponding guideway actuating plates 11. Two guideways 20, which have different heights, are vertically provided on each guideway actuating plate 11 at positions adjacent to each other.

Furthermore, the two guideways 20 are vertically supported on a corresponding guideway support plate 21, which moves along the horizontal screw 12 on each guideway actuating plate 11. The outer surfaces of the two guideways 20 are in close contact with a corresponding support frame 22, such that the guideways 20 are reliably supported thereon.

Each guideway 20 has therein a vertical screw 23, which extends along the longitudinal axis of the guideway 20. A motor 24 for independently operating the vertical screw 23 is provided on the upper end of each vertical screw 23, that is, on the upper end of each guideway 20.

Furthermore, a footboard actuating unit 25 is provided on each vertical screw 23. Depending on the rotation of the vertical screw 25 using the operation of the motor 24, the footboard actuating unit 25 is moved upwards or downwards along the vertical screw 23 inside the corresponding support frame 22.

Here, a stopper 26 is provided on the upper end of each vertical screw 23 to prevent the footboard actuating unit 25 from colliding with the motor 24 or the output shaft of the motor when moving upwards.

The horizontal screw of each guideway actuating plate 11, which moves the corresponding guideway 20 in the horizontal direction, and the vertical screw 23, which is installed in each guideway 20, are coupled to the motors 13 and 24 through respective ball screws 27. The rotating force of each motor 13, 24 is transmitted to the corresponding screw 12, 23 through the corresponding ball screw 27.

Meanwhile, each footboard 30 is coupled at opposite ends of one edge thereof to the two footboard actuating units 25, which are installed in the two adjacent guideways 20, so that, depending on the individual movement of the two footboard actuating units 25, the height of the opposite ends of the footboard 30 are adjusted.

The opposite ends of the footboard 30 are supported on respective footboard support rods 28, which extend towards the center of the apparatus from the respective footboard actuating units 25, which are provided in the corresponding guideways 20. Here, the footboard 30 is coupled to the footboard support rods 28 such that the front and rear parts of the footboard 30 are rotatable relative to the respective footboard support rods 28 depending on the individual vertical movement of the footboard actuating units 25.

That is, the footboard 30 is operated such that the upper surface of the footboard 30, on which the sole of the foot of the user is supported at an angle corresponding to the angle at which the sole is angled to the ground when the user really walks. Thus, the user, who places his/her feet on the respective footboards 30 and conducts gait training, can train the lower body in a manner similar to that when actually walking.

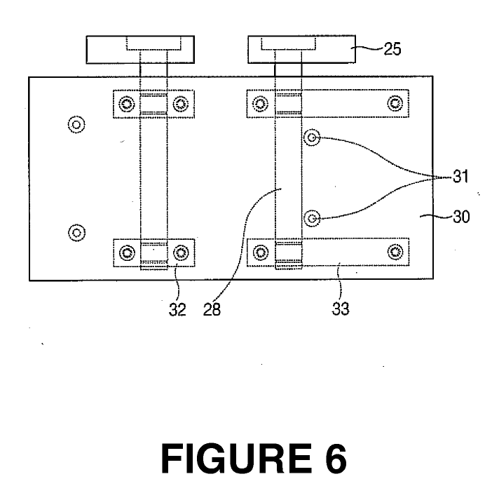

With regard to the detailed description of the footboard actuating units 25 and the footboard 30, the installation structure and the operation of the footboard 30 will be explained in detail with reference to FIGS. 6 through 10.

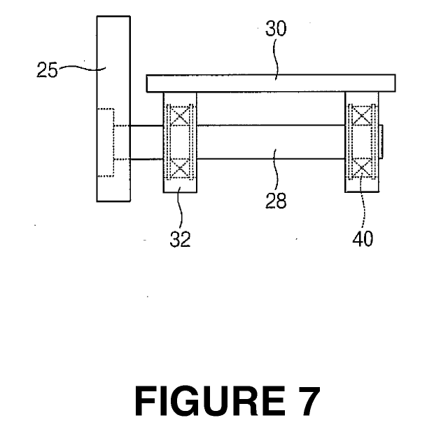

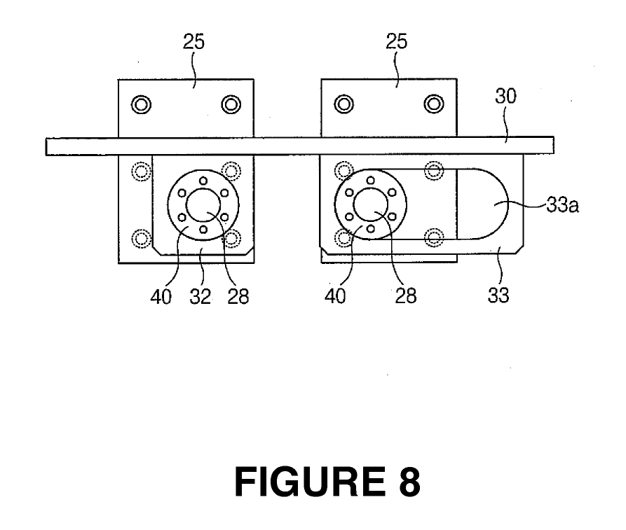

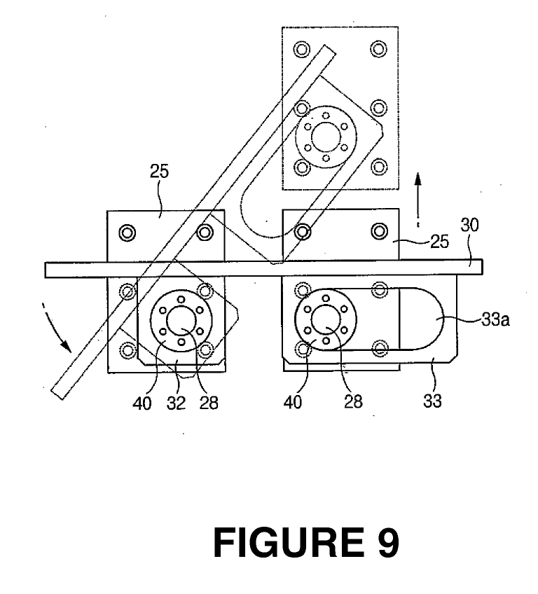

FIG. 6 is a plan view of the footboard actuating unit used in the gait trajectory guiding device according to the present invention. FIG. 7 is a front view of the footboard actuating unit used in the gait trajectory guiding device according to the present invention. FIG. 8 is a side view of the footboard actuating unit used in the gait trajectory guiding device according to the present invention. FIGS. 9 and 10 are views illustrating the operation of the footboard actuating unit used in the gait trajectory guiding device according to the present invention.

As shown in the drawings, each footboard 30 has a planar shape. Pressure sensors 31 for measuring the pressure of the foot, which is placed on the upper surface of the footboard 30, are installed in the four respective quadrants of the upper surface of the footboard 30.

The pressure sensors 31 measure the pressure of the feet when gait training, in real time, convert the measured pressure into pressure signals, and transmit the pressure signals to a PC, which is electrically connected to the footboards 30 and is installed in the gait rehabilitation apparatus.

Preferably, to precisely measure the foot pressure applied to the footboard 30, the pressure sensors 31 are disposed adjacent to the four respective corners of the portion on which the foot is placed, such that the pressure sensors 31 can measure the average foot pressure of the front, rear, left and right portion of the sole of the foot, which is placed on the footboard 30.

Here, a load cell is typically used as each pressure sensor 31.

It is preferable that each footboard 30 be made of synthetic resin having a predetermined elasticity to reliably support the sole of the foot of the user and to stably maintain the foot at the correct position when the footboard 30 is actuated.

In the footboard 30 having the above-mentioned structure, support rod coupling members 32 and 33 extend downwards from the opposite ends of the lower surface of the footboard 30. Each footboard support rod 28, which extends from the corresponding footboard actuating units 25, is inserted into the corresponding support rod coupling members 32, 33.

Each footboard support rod 28, which extends from the corresponding footboard actuating unit 25, has a cylindrical shape. A bearing 40 is installed in each support rod coupling member 32, 33. The support rod coupling members 32 and 33 are rotatably fitted over the corresponding footboard support rods 28. Thus, in response to the difference in height between the footboard actuating units 25 due to individual vertical movement of the footboard actuating units 25, the support rod coupling members 32 and 33 rotate relative to the corresponding footboard support rods 28 such that the front and rear parts of the footboard 30 are oriented at a predetermined angle.

Meanwhile, the support rod coupling members 32 and 33, which are disposed at front and rear positions, have different shapes from each other. In detail, each front support rod coupling member 32 has a circular through hole, into which the corresponding cylindrical footboard support rod 28 is closely inserted in the state in which the bearing 40 is interposed therebetween. Each rear support rod coupling member 33 has a coupling slot 33a extending a predetermined length such that the corresponding footboard support rod 28 is movable in the coupling slot 33a.

The footboard support rod 28 of the footboard actuating unit 25, which is inserted into the coupling slot 33a, is moved in the coupling slot 33a when the corresponding footboard actuating unit 25 moves upward or downwards. Thanks to the movement of the footboard support rod 28, the footboard 30 can be smoothly rotated at a predetermined angle with respect to the footboard actuating unit 25.

In other words, as shown in FIGS. 9 and 10, when the footboard 30, which has been in a horizontal state, is rotated at an incline around the front footboard support rod 28 by the upward movement of the footboard actuating unit 25, which is provided in the rear guideway 20, the footboard actuating unit 25, which is inserted in the coupling slot 33a, is rotated and moved from the front end to the rear end in the coupling slot 33a. Therefore, the inclination of the footboard 30 can be smoothly adjusted at a desired angle.

Here, a bearing that can move and rotate in the coupling slot 33a at the same time is preferably used as the bearing 40, which is interposed between the rear footboard support rod 28 and the coupling slot 33a. Typically, a roller type bearing, which can implement linear movement and rotation at the same time, is used as the bearing 40.

As such, in response to the individual vertical movement of the footboard actuating units 25, which are installed in the respective guideways 20, the footboards 30, which are disposed inside the guideways 20, are actuated at angles corresponding to the angles of the feet when actually walking.

With regard to this, the orientation of the footboard 30 will be explained in detail with reference to the following schematic views.

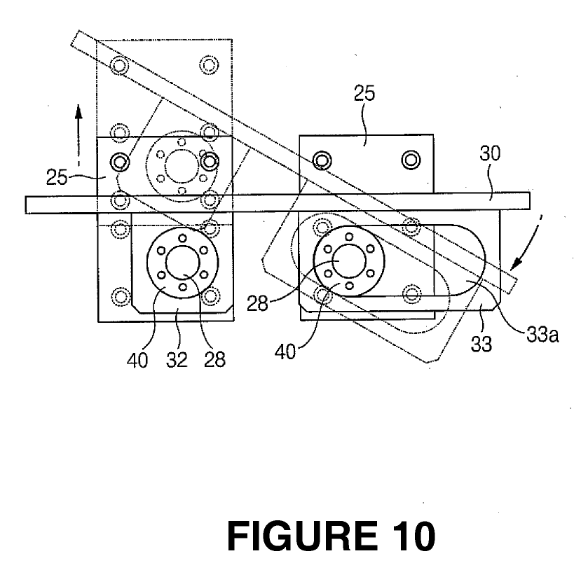

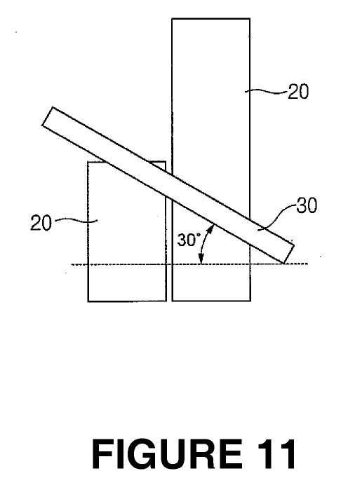

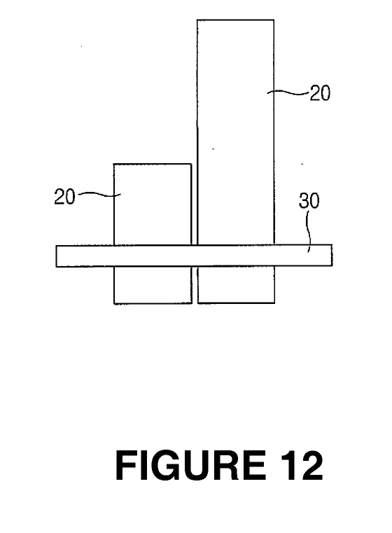

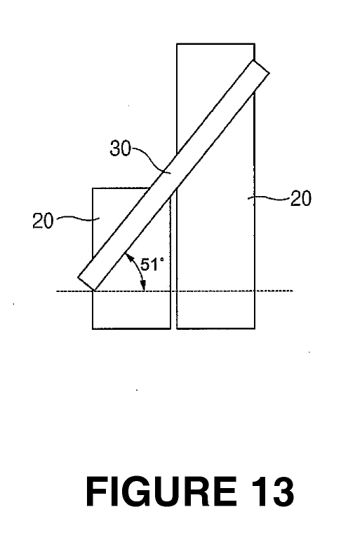

FIGS. 11 through 13 are schematic views showing the orientation of the footboard of the gait trajectory guiding device when it is actuated according to the present invention. FIG. 11 is a schematic view when the heel of the foot is supported. FIG. 12 is a schematic view when the entire sole of the foot contacts the ground. FIG. 13 is a schematic view in the case where the toes of the foot are supported when the foot pushes the ground to generate propulsive force.

Before the detailed description of the drawings is given, the movement of the feet when generally walking will be briefly described herein below. When beginning a step, the knee of one leg is bent, and the foot is lifted. Thereafter, the lifted foot is advanced, and the sole of the foot is brought into contact with the ground. Subsequently, the toes are brought into contact with the ground, and, simultaneously, the knee, which has been bent, is stretched. At this time, repulsive force is generated, so that the upper body is advanced forwards by the repulsive force.

When the upper body is advanced forwards, the knee of the other leg is bent, and the foot thereof is lifted. In the state in which the walker takes a step forwards, the sole of the lifted foot is brought into contact with the ground, and the above-mentioned motion is repeated. At this time, the heel of the foot of the leg, which has served as a thrust shaft, and the sole of which has been in contact with the ground, is first separated from the ground, and the other leg becomes a thrust shaft, thus advancing the upper body forwards.

To smoothly embody such repeated movement of the feet on the footboards, the angles of the footboards when actuated must be set to simulate actual walking.

In detail, as shown in FIGS. 11 through 13, typically, when the walker advances one leg and the sole of the foot is brought into contact with the ground to obtain propulsive force, the angle between the sole of the foot and the ground is approximately 32.28°. When the heel of the foot is maximally lifted in the state in which only the toes contact the ground to take a next step after the sole of the foot contacts the ground, the angle between the sole and the ground is approximately 56.68°.

The operation of the footboards to realize the optimum angles between the sole of the foot and the ground when actually walking is as follows.

First, from the state in which the footboard 30, which is coupled to the two adjacent guideways 20, is oriented in the horizontal direction, when beginning a step, the footboard 30 is rotated at a predetermined angle such that the front part thereof is moved upwards. For this, the footboard actuating unit 25 of the front guideway 20, which is coupled to the front part of the footboard 30, is moved upwards. Thereby, the front part of the footboard 30 is moved upwards, so that the footboard 30 forms the inclined surface in the same shape as that, when the heel of the foot is brought into contact with the ground.

At this time, the angle of the inclined footboard 30 ranges from approximately 30° to approximately 32° on the rear footboard support rod 28.

Thereafter, so that the foot, which is supported on the footboard 30, is in the same state as that when the entire sole of the foot is in contact with the ground, the footboard actuating unit 25 of the front guideway 20, which has been moved upwards, is moved downwards, thus orienting the footboard 30 parallel to the ground.

Subsequently, to generate propulsive force using repulsive force generated when the sole of the foot pushes the ground, the footboard 30, which has been in the horizontal state, is rotated such that the rear part of the footboard 30, which supports the heel of the foot, is moved upwards, thus forming a shape similar to the shape in which only the toes contact the ground.

For this, the footboard actuating unit 25 of the rear guideway 20, which is coupled to the rear part of the footboard 30, is moved upwards. Here, as described above, the footboard support rod 28, which is coupled to the support rod coupling member 33 of the footboard 30, is moved along the coupling slot 33a, thus making the rotation of the footboard 30 possible.

At this time, the angle of the inclined footboard 30 ranges from approximately 51° to approximately 56° on the front footboard support rod 28.

Subsequently, the footboard actuating unit 25, which is coupled to the rear part of the footboard 30, is moved downwards and, simultaneously, the front footboard actuating unit 25 is moved upwards, so that the footboard 30 enters the horizontal state again. Continuously, the footboard actuating unit 25, which is coupled to the rear part of the footboard 30, is moved downwards to the lowermost position, thus entering the state of FIG. 11 again. The above-mentioned operation is repeatedly conducted.

The footboard 30 continuously conducts the above-mentioned series of processes. The two footboards 30, which are disposed parallel to each other at positions facing each other and corresponding to the width of the stance of the user, are actuated alternately.

The gait trajectory guiding device according to the present invention having the above-mentioned construction and operation is technically characterized in that it is operated such that, when the footboards 30 are actuated in the state in which the feet of the user are placed on the respective footboards 30, the feet and the ankles of the user, in addition to the knees, which move in conjunction with the ankles, can move in the same way as when actually walking.

Furthermore, in the present invention, when a gait trajectory suitable for the user is input using a display unit (not shown), which is provided on the gait rehabilitation apparatus, exercise conditions, such as a gait speed, the length of the step, the exercise extent of the ankle and knee, etc., are adjusted to be suitable for the user according to the preset program.

Although the preferred embodiment of the present invention has been disclosed for illustrative purposes, those skilled in the art will appreciate that various modifications, additions and substitutions are possible, without departing from the scope and spirit of the invention as disclosed in the accompanying claims. Furthermore, these modifications, additions and substitutions must be regarded as falling within the bounds of the accompanying claims.

1. A gait trajectory guiding device of a gait rehabilitation apparatus, in which a gait trajectory is adjustable to correspond to an exercise ability of a user, the gait trajectory guiding device comprising:
a pair of guideway actuating plates supported on a ground and arranged parallel to each other, with a horizontal screw provided through each of the guideway actuating plates along a longitudinal axis thereof;
a pair of guideways provided on each of the guideway actuating plates, each of the guideways being individually moved by rotation of a corresponding horizontal screw in a longitudinal direct ion of the guideway actuating plate; and
footboards coupled to inner portions of the guideways to correspond to each other, the footboards being coupled to the guideways such that front and rear parts of each of the footboards are individually adjustable in height.

2. The gait trajectory guiding device of the gait rehabilitation apparatus according to claim 1, wherein each of the guideway actuating plates is provided at one end thereof with a motor for rotating the corresponding horizontal screw.

3. The gait trajectory guiding device of the gait rehabilitation apparatus according to claim 1, wherein the guideways are provided parallel to each other on a guideway support plate, which is moved forwards or backwards on each of the guideway actuating plates, the guideways being oriented in vertical directions and being surrounded and supported by a guideway support frame, which is vertically provided on edges of the guideway support plate.

4. The gait trajectory guiding device of the gait rehabilitation apparatus according to claim 3, wherein one selected from between the pair of guideways is higher than a remaining one of the pair of guideways.

5. The gait trajectory guiding device of the gait rehabilitation apparatus according to claim 1, wherein a vertical screw is provided in each of the guideways, and a footboard actuating unit is provided on the vertical screw so as to be movable upwards or downwards.

6. The gait trajectory guiding device of the gait rehabilitation apparatus according to claim 5, wherein each of the guideways is provided on an upper end thereof with a motor for rotating, the corresponding vertical screw.

7. The gait trajectory guiding device of the gait rehabilitation apparatus according to claim 2, wherein the motor transmits a rotating force to the horizontal screw or the vertical screw through a ball screw.

8. The gait trajectory guiding device of the gait rehabilitation apparatus according to claim 1, wherein the front and rear parts of each of the footboards are supported by the respective footboard actuating units, which are vertically operated in the pair of guideways by the corresponding vertical screws.

9. The gait trajectory guiding device of the gait rehabilitation apparatus according to claim 1, wherein each of the footboards has a planar shape, a plurality of pressure sensors is provided in an upper surface of the footboard, and support rod coupling members are provided at two respective positions under a lower surface of the footboard.

10. The gait trajectory guiding device of the gait rehabilitation apparatus according to claim 9, wherein one selected from between the pair of support rod coupling members has a coupling slot extending a predetermined length.

11. The gait trajectory guiding device of the gait rehabilitation apparatus according to claim 5, wherein the support rod coupling members extending downwards from the footboard are coupled to footboard support rods, which extend inwards from the respective footboard actuating units, so that the front and rear parts of the footboard are rotated around the corresponding footboard support rods by the footboard actuating units, which are individually moved upwards or downwards along the corresponding vertical screws.

12. The gait trajectory guiding device of the gait rehabilitation apparatus according to claim 11, wherein one selected from the footboard support rods extending from the footboard actuating units is inserted into the coupling slot, wherein, when the footboard actuating units individually move in the vertical directions, the footboard support rod moves along the coupling slot.

13. The gait trajectory guiding device of the gait rehabilitation apparatus according to claim 1, wherein each of the guideway actuating plates comprises a linear footboard moving unit including the corresponding horizontal screw and the guideways comprises a linear footboard moving unit including the corresponding vertical screw.

14. The gait trajectory guiding device of the gait rehabilitation apparatus according to claim 6, wherein the motor transmits a rotating force to the horizontal screw or the vertical screw through a ball screw.

15. The gait trajectory guiding device of the gait rehabilitation apparatus according to claim 5, wherein the front and rear parts of each of the footboards are supported by the respective footboard actuating units, which are vertically operated in the pair of guideways by the corresponding vertical screws.

16. The gait trajectory guiding device of the gait rehabilitation apparatus according to claim 9, wherein the support rod coupling members extending downwards from the footboard are coupled to footboard support rods, which extend inwards from the respective footboard actuating units, so that the front and rear parts of the footboard are rotated around the corresponding footboard support rods by the footboard actuating units, which are individually moved upwards or downwards along the corresponding vertical screws.

17. The gait trajectory guiding device of the gait rehabilitation apparatus according to claim 16, wherein one selected from the footboard support rods extending from the footboard actuating units is inserted into the coupling slot, wherein, when the footboard actuating units individually move in the vertical directions, the footboard support rod moves along the coupling slot.
